(19) United States
(12) Patent Application Publication
(10) Pub. No.: US 2006/0190343 A1
(43) Pub. Date: Aug. 24, 2006

(54) Method of marketing memberships in a consumer group

(75) Inventor: Merle Eugene Cooper, Bethany, MO (US)

Correspondence Address: DORSEY & WHITNEY LLP;INTELLECTUAL PROPERTY DEPARTMENT, 801 GRAND, SUITE 3900, DES MOINES, IA, 50309, US

(73) Assignee: Word of Mouth Marketing, Inc.

(21) Appl. No.: 11/065,011

(22) Filed: Feb. 24, 2005

(51) Int. Cl. G06Q 30/00

(52) U.S. Cl. 705/26

(57) ABSTRACT

An organization is presented that includes members of a consumer group. A facilitator coordinates and issues memberships in the organization. The facilitator negotiates with suppliers for favorable deals for members of the organization. The memberships are sold primarily by existing members. For each membership sold, a facilitator fee is paid to the facilitator, and a commission is paid to one of the members. A tree-like logic structure is used to determine which member is entitled to the commission. The first specified number of membership sales made by a member are qualifying sales for which the commission is paid to the member at the top of the tree. For all sales after the specified number, the member becomes the top member of a new tree and is entitled to all commissions from qualifying sales of all progeny.

### FIELD OF INVENTION

This invention relates generally to a methods of marketing and more particularly to a method for marketing memberships in a consumer group through membership sales made by the members themselves.

### BACKGROUND

Groups of purchasers that act in concert have more buying power than individuals. There are numerous reasons for this. Most importantly, a seller is willing and able to accept a lower price for each item or service sold, if the seller has an increased volume of sales. Trade groups and co-operatives are structures for pooling groups of purchasers and thereby increase the buying power of the members. Similarly, retail stores have been formed that require payment of a “membership” fee before a customer is permitted to shop. However, there has not been an effective organization for consolidating the buying power of large numbers of individual consumers across a wide variety of goods and services from a large variety of sources.

The more members a consumer group has, the more buying power it will have to negotiate favorable deals from suppliers. Therefore it is beneficial for such groups to attract large numbers of members. Furthermore, the greater the buying power such a group has, the easier it is for it to attract members because of the favorable deals obtained from the great buying power. Paradoxically, the fewer members a group has, the less buying power it will have, and the more difficult it will be to attract new members. It can therefore be difficult to start such a group because, until there are members, there is no buying power.

It is well understood that one of the most effective sources for new customers is recommendations from current and past customers. Sellers have tried to take provide an incentive for such recommendations by providing discounts or other perks when an existing customer or member recruits a new customer or member.

Therefore, there exists a need for a method that takes advantage of recommended sales to create a large consumer group that uses it buying power to achieve favorable terms from suppliers. In particular there is a need for providing sufficient incentive for people to join the group in order to create sufficient numbers of members to create significant buying power.

### SUMMARY OF THE INVENTION

According to one embodiment, the present invention provides an organization comprising a facilitator and a membership group of member consumers. The facilitator negotiates with suppliers for favorable terms for group members. The members all pay a membership fee to join the membership. The membership fee is divided into a facilitator fee and a commission. The facilitator retains the facilitator fee, and distributes the commission to a single appropriate member. The member to whom the commission is paid is determined according to a set of rules. The rules provide a tree structure for determining how the commission is paid. According to the tree structure, the first specified number of sales by a member are qualifying sales, for which the commission is paid to an associate at the top of the tree. All sales after the specified number are commission sales for which the commission is paid to the member who made the sale. Furthermore, for all sales after the specified number, the member making the sale becomes the associate at the top of a new tree structure.

### BRIEF DESCRIPTION OF THE DRAWINGS

FIG. 1 is a schematic illustrating the structure of an organization according to one embodiment of the present invention;

FIG. 2 is a graphic illustration of the components of a membership fee;

FIG. 3 is a schematic illustrating the make-up of the members of the organization of FIG. 1; and

FIG. 4 illustrates a tree structure for determining payment of commissions according to the present invention.

### DETAILED DESCRIPTION OF PREFERRED EMBODIMENTS

This invention relates to a method of organizing consumers into a group to increase their buy power. The members of the group market memberships to other individuals in order to increase the membership in the group. The members will receive the benefit of increased buying power by terms that are negotiated on their behalf by a facilitator. The members are provided with an incentive to market memberships through a commission reward structure that is determined by a tree structure. The following discussion, examples, and attached drawings describe the features of the invention.

FIG. 1 shows provides a graphic illustration of an organization 10 formed according to the present invention. The organization consists of a facilitator 12 and group members 14. The facilitator acts as the organizing and overseeing entity. In practice, the facilitator is likely to be business entity, but could be an individual. The members of the group are preferably individual consumers, but could conceivably be groups of individuals, such as husbands and wife, families, or business entities. The duties of the facilitator 12 will be described in further detail below. However, one of the primary duties of the facilitator 12 will be to negotiate favorable terms with suppliers 16 on behalf of the group members 14. The suppliers 16 may be any entity that sells goods or services that might be desired by group members 14.

The list of potential suppliers 16 and their goods and services is unlimited. By way of example only, some of the preferred goods and services include: housing, automobiles, boats, recreational vehicles, appliances, home mortgages, auto loans, travel, motels, car rentals, vacations packages, home improvement, internet access, long distance, televisions, stereos, computers, car parts, heating and cooling systems, groceries, hardware supplies, sporting equipment, clothing, and restaurants. The favorable terms could be in the form of reduced prices, preferential treatment, larger or earlier availability of goods and services, or any other terms related to the sale of good and services. It is expected that suppliers 16 will desire to provide the favorable terms because of the large number of customers that would be made available from the members 14. Naturally the more members 14 that belong to the organization 10, the greater the incentive the suppliers 16 will have to provide favorable terms. To provide additional incentive to suppliers 16 to provide favorable terms, it may be desirable to have only a single supplier of any one good or service. For example, it may be worth more to a supplier of televisions to provide favorable terms, if the supplier knows that it will be the only supplier that has an agreement with the organization 10.

All members 14 of the organization are entitled to the benefits of the favorable terms with the suppliers 16. The preferred method of becoming a member 12 is through the payment of a membership fee 18. According to the preferred embodiment the membership fee 18 purchases a membership for a specified time period, preferably for two years. A reduced renewal fee may be offered to renew the membership for a period of time. Alternatively, the membership fee could be a onetime payment that is good for the life of the member 14.

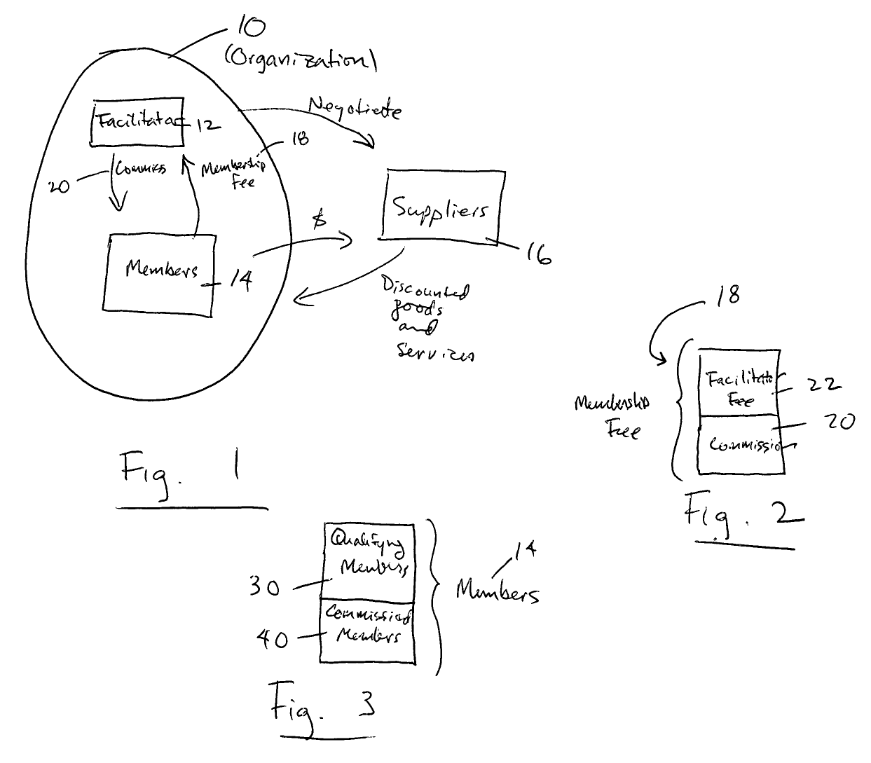

The primary mechanism for the sale of memberships is by existing members to new members. In order to provide an incentive to the members 14 to market memberships in the organization 10, a single commission 20 is paid from each membership fee 18. As illustrated in FIG. 2, the remainder of the membership fee is retained by the facilitator 12 as a facilitator fee 22. In a preferred embodiment the commission 20 and the facilitator fee 22 each represent about half of the membership fee 18. In a most preferred embodiment, the membership fee would be $79.00, the commission would $40.00, and the facilitator fee 22 would be $39.00, such a majority of each membership fee 18 would be paid to a member 14 as a commission 20. A unique tree-like logic structure is used to determine who is entitled to the commission 20.

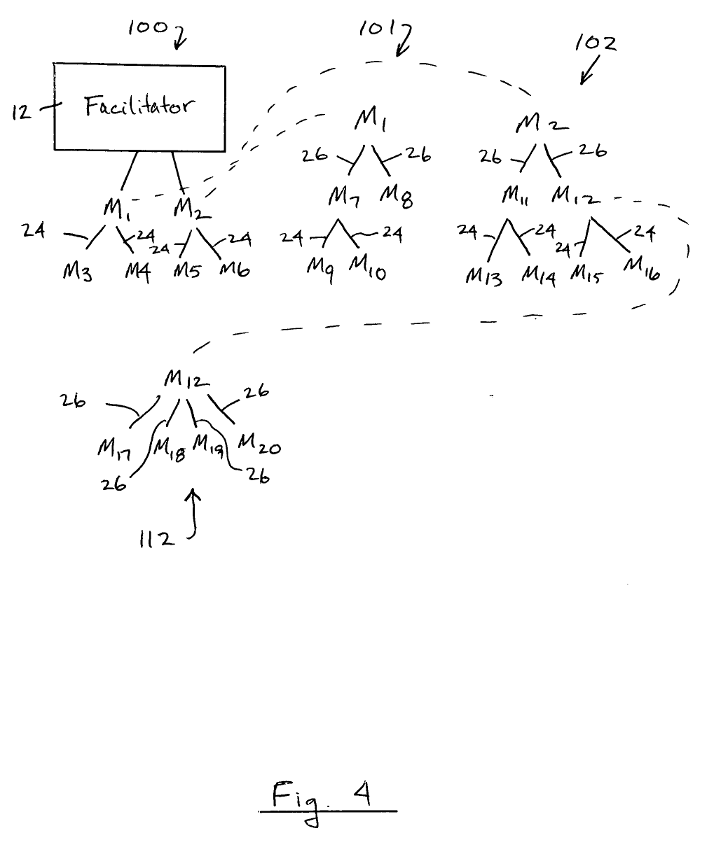

A member must make a minimum specified number of sales before the member 14 is eligible to receive a commission 20. Therefore, as shown in FIG. 3, the entire membership can be divided into two classes of members: qualifying members 30 and commissioned members 40. Qualifying members 30 are members 14 who have not yet made enough sales of memberships to be eligible to receive a commission 20. Commissioned members 40 are members that have made more than the specified numbers of sales, such that they are entitled to receive a commission 20.

The rules for forming the tree-like logic structure are conceptually shown in FIG. 4. Each sale of a membership is placed within a tree-like structure 100. According to the rules, a specified number of sales are considered to be qualifying sales 24. The first specified number of sales by a member are qualifying sales 24, for which the commission 20 is paid to the member at the top of the tree 100. It should be appreciated that the member at the top of any tree will be a commissioned member 40, except for the case of the initial members, who purchased their membership from the facilitator 12, and who would take the place of the commissioned member 40 at the top of the tree 100. All sales after the specified number of sales made by a given member are commission sales 26 for which the commission 20 is paid to the member 40 who made the sale. Furthermore, for all sales after the specified number, the member 14 making the sale becomes the commissioned member at the top of a new tree structure 100. According to an alternative, a person could become a commissioned salesperson without becoming a member by selling the specified number of memberships plus one additional membership.

FIG. 4 illustrates an example of the preferred embodiment wherein the specified number of sales required to become a commissioned member 40 is two. According to this example, the facilitator 12 makes two initial sales of memberships to initial members M1 and M2. The facilitator is at the top of the tree 100, and is entitled to retain the commission 20 from the membership fees 18. M1 makes two qualifying sales 24 to new members M3 and M4. For each additional sale M1 makes after the two qualifying sales 24, M1 will be at the top of a new tree 101, and the additional sales will be commission sales 26. Therefore, in tree 101, the sales 26 of new memberships to members M7 and M8 result in M1 being paid the resulting commission 20. Additionally, because M1 is at the top of tree 101, the commissions 20 from the first two sales by both M7 and M8 also go to M1. The entire tree 101 of qualifying sales 24 result in commissions 20 being paid to M1.

A similar tree 102 results for member M2, who according to this example makes commission sales 26 of memberships to M11, M12, and M13, for which M2 would be paid a commission. Additionally, all of the qualifying sales made by M11, M12, and M13 would result in commissions being paid to M2 as the commissioned member 40 at the top of the tree. Indeed all of the commissions 20 resulting from qualifying sales made by the qualifying members 30 that are descendants from the qualifying sales of M11, M12, and M13 would belong to M2. Additionally new tree 112 is created when M12 makes commission sales 26 to M17, M18, M19, and M20.

It is expected that the facilitator 12 will handle distribution of the commissions 20. According to the preferred embodiment, the membership fee 18 is paid directly to the facilitator 12. The facilitator 12 keeps track of the trees 100, and pays the commission 20 to the appropriate member 14 or sales person 50. The trees 100 may be preferably mapped using a processing unit and computer software, but may also be done in hard copy on paper. The facilitator will preferably provide information packs including information explaining how the tree structure and membership sales program works, marketing information to provide to prospective members, and other similar information. The information may be provided as a combination of written materials and electronic software, such as a DVD. Prospective members may be required to sign an membership agreement setting forth the terms of the membership.

It is expected that members 14 will be issued membership cards that can be shown to participating suppliers 16 as proof of membership in the organization 10. Preferably these card will have magnetic strips with associated information that can be read by standard swipe-type card readers. The cards may also be imprinted with the member's 14 name, photograph, and other identifying information. Participating suppliers 16 may be provided with material such as signage and stickers so that members 14 and prospective members will be aware that the supplier 16 participates in the program.

The above described invention therefore provides an organization 10 that gives individual consumers the buying power of a large group. The system for determining payment of commissions to members will encourage marketing of the organization 10 to be accomplished almost exclusively by group members 14 themselves. Third parties will desire to become members because of both the buying power benefits, and the chance to earn commissions on sales of memberships. As the number of members 14 increases, the buying power of the organization will increase, permitting the facilitator 12 to negotiate better and better deals on behalf of the members 12, which in turn will make provide still additional incentive for new people to become members 14.

Although the present invention has been described with a certain degree of particularity, it is understood that the disclosure has been made by way of example, and changes in detail or structure may be made without departing from the spirit of the invention as defined in the appended claims.

I claim:

1. A method of marketing memberships in an organization, the method comprising:
selling a membership in the organization to an initial member;
permitting that initial member to sell memberships in the organization to subsequent members in exchange for payment of a membership fee by each subsequent member;
dividing each membership fee into a facilitator fee and a commission, and retaining the facilitator fee and paying out the commission fee to a deserving member; and
determining the deserving member through use of a tree-like logic structure whereby the first specified number of sales by a member are qualifying sales, for which the deserving member is the member at the top of the tree-like logic structure and further whereby sales after the specified number are commission sales for which the deserving member is the member who made the sale, and furthermore, whereby for all sales after the specified number, the member making the sale becomes the member at the top of a new tree structure.

2. The method of claim 1, further comprises negotiating favorable terms from suppliers on behalf of the members.
